(19) United States
(12) Patent Application Publication
(10) Pub. No.: US 2008/0242411 A1
(43) Pub. Date: Oct. 2, 2008

(54) GAMING MACHINE WITH SOUND EFFECTS

(75) Inventor: Paul Stuart Connelly, Springwood NSW (AU)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY, LTD, Lane Cove NSW (AU)

(21) Appl. No.: 12/060,691

(22) Filed: Apr. 1, 2008

(30) Foreign Application Priority Data
Apr. 2, 2007 (AU) 2007901756

(51) Int. Cl. A63F 9/24; G06F 9/44; G06F 17/30

(52) U.S. Cl. 463/35; 463/20; 463/37; 717/106; 707/201

(57) ABSTRACT

A gaming machine comprising a display operable to display a sequence of gaming events in a wagering game, each gaming event in the sequence being displayed at a respective location on the display; and a plurality of speakers operable to play gaming sounds to accompany the sequence of gaming events, wherein a relative volume of each gaming sound in each speaker depends on the location of the corresponding displayed gaming event.

### FIELD OF THE INVENTION

The present invention generally relates to gaming machines. A particular embodiment of the present invention relates to the provision of sound effects to accompany events displayed in a game played on a gaming machine.

### BACKGROUND OF THE INVENTION

With the increase of gambling at gaming venues has come increased competition between gaming venues to obtain a larger share of the total gambling spend. Gaming venue operators have therefore continuously looked for new variations and types of games in order to attract both new and return customers to their venues.

In response to this need, suppliers of gaming devices and systems have attempted to provide the sought-after variety, while still developing games that comply with the relevant regulations in the jurisdiction of the gaming venue operator. Suppliers of gaming devices therefore are faced with restrictions on the types of games and gaming machines that are allowable, both in terms of the prevailing regulations and in terms of providing a return on investment to the gaming venue operators.

### SUMMARY OF THE INVENTION

According to a first aspect of the invention there is provided a gaming machine comprising:

a display operable to display a sequence of gaming events in a wagering game, each gaming event in the sequence being displayed at a respective location on the display; and

a plurality of speakers operable to play gaming sounds to accompany the sequence of gaming events, wherein a relative volume of each gaming sound in each speaker depends on the location of the corresponding displayed gaming event.

The display may be operable to display a plurality of spinning reels in the wagering game and the sequence of gaming events comprises the spinning reels stopping in turn to show at least one symbol.

The plurality of speakers may play a gaming sound to accompany a corresponding spinning reel stopping on the display.

The plurality of speakers may comprise a left speaker and a right speaker and the display may have a left side and a right side wherein, in the wagering game, the plurality of reels is distributed between the left side and the right side and the relative volume of the gaming sound on the left speaker and the right speaker depends on the relative location of the corresponding reel between the left side and the right side.

The gaming machine may comprise data storage to store at least one gaming sound.

The data storage may store the or each gaming sound as a stereo pair.

The gaming machine may comprise means to retrieve at least one gaming sound from the data storage and a driver to play the retrieved sound over the plurality of speakers.

The location of the gaming event may move during display of the gaming event and the relative volume of accompanying gaming sound played through the speakers may vary corresponding to the movement of the location of the displayed gaming event.

According to a second aspect of the invention there is provided a method of providing sound effects for a wagering game played on a gaming machine having a display and a plurality of speakers, the method comprising:

displaying a sequence of gaming events in the wagering game, each gaming event being displayed at a respective location on the display; and, for each displayed gaming event

playing a gaming sound through the plurality of speakers to accompany the displayed gaming event, wherein a relative volume of the gaming sound in each speaker depends on the location of the displayed gaming event.

The method may further include operating the display to display a plurality of spinning reels in the wagering game, and the sequence of gaming events comprises the spinning reels stopping in turn to show at least one symbol.

The method may further include playing a gaming sound on the plurality of speakers to accompany a corresponding spinning reel stopping on the display.

The plurality of speakers may comprise a left speaker and a right speaker and the display may have a left side and a right side wherein, in the wagering game, the plurality of reels is distributed between the left side and the right side, and wherein the method further includes varying the relative volume of the gaming sound on the left speaker and the right speaker depending on the relative location of the corresponding reel between the left side and the right side.

At least one gaming sound may be stored on a data storage.

The or each gaming sound is stored on the data storage as a stereo pair.

The method further may further comprise retrieving at least one gaming sound from the data storage and playing the retrieved sound over the plurality of speakers.

The location of the gaming event may move during display of the gaming event, in which case the method may further include varying the relative volume of accompanying gaming sound played through the speakers according to the movement of the location of the displayed gaming event.

According to a further aspect, the invention broadly resides in instructions executable by a game controller to implement the method as described in the immediately preceding paragraphs and to such instructions when stored in a storage medium readable by the game controller or transmitted via a data stream.

Further aspects of the present invention will become apparent from the following description, given by way of example only and with reference to the accompanying drawings.

### BRIEF DESCRIPTION OF THE DRAWINGS

Certain embodiments of the invention will now be described in relation to the following drawings in which:

FIG. 1: shows a view of a gaming console suitable for implementing certain embodiments of the present invention.

FIG. 2: shows a block diagram of gaming machine suitable for implementing certain embodiments of the present invention.

FIG. 3: shows a block diagram of components of the memory of the gaming machine represented in FIG. 2.

FIG. 4: shows a schematic view of a network gaming system suitable for implementing certain embodiments of the present invention.

FIG. 5: shows a schematic view of 5 spinning reels displayed in a wagering game played on the gaming machines of FIGS. 1 to 4.

FIG. 6: shows a flow diagram of a method of playing sounds to accompany the spinning reel game of FIG. 5.

FIGS. 7A-E: illustrate gaming sounds associated with the spinning reels of FIG. 5 in the method of FIG. 6.

FIG. 8: shows an overview of the stereo pairs of gaming sounds used in the method of FIG. 6.

### DETAILED DESCRIPTION OF THE EMBODIMENTS

Operating Environment

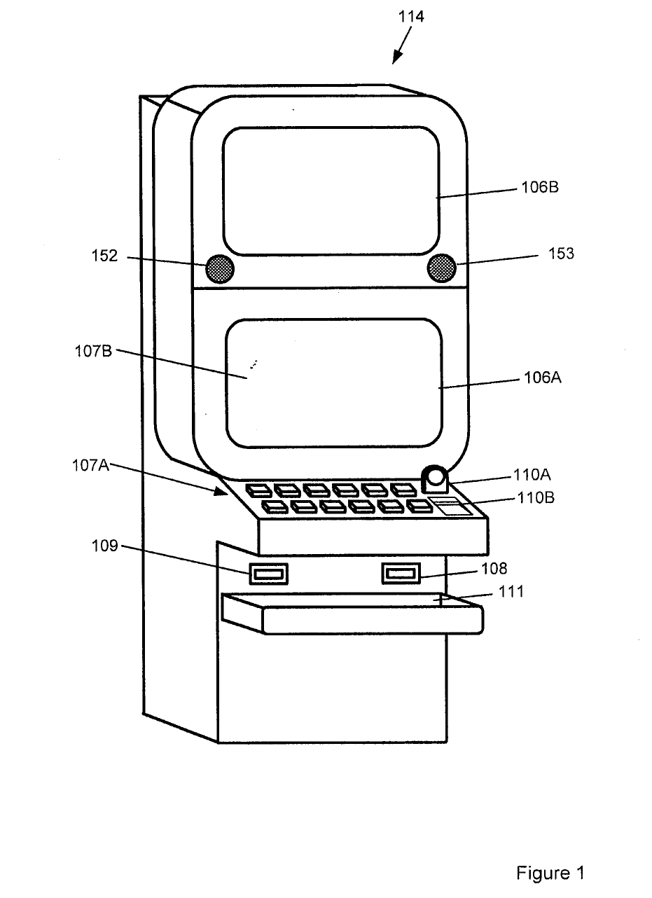

In FIG. 1 of the accompanying drawings, one example of a gaming console that is suitable to implement certain embodiments of the present invention is generally referenced by arrow 114.

The gaming console 114 includes two displays 106A, 106B on one or both of which is displayed representations of a game that can be played by a player and a bank of buttons 107A and/or a touch screen 107B to enable a player to play the game. The displays 106 may be video display units, such as a cathode-ray-tube screen device, a liquid crystal display, plasma screen, any other suitable video display unit, or the visible portion of an electromechanical device. The display 106B may display artwork, including for example, pay tables and details of bonus awards and other information or images relating to the game. In alternative gaming consoles the display 106B may be omitted, or optionally replaced by a static display.

The gaming console 114 also includes audio system. In one arrangement the console 114 includes a left speaker 152 and a right speaker 153. In other arrangements additional speakers may be provided on the console 114. Furthermore, other speakers may be disposed around a player of the gaming console 114 to enable the provision of surround sound. In the arrangements described herein, the audio system provides multi-channel sound and thus different sound channels may be played through the left speaker 152 and the right speaker 153. By using two channels, a sound can be designed to have dominance in one or other of speakers 152, 153 or to be balanced between both speakers.

A credit input including a coin input 110A and/or bill collector 110B allows a player to provide credit for wagering and a coin output 111 is provided for cash payouts from the gaming console 114. A card and/or ticket reader 108 and a printer 109 may be provided to provide player tracking, cashless game play or other gaming and non-gaming related functions.

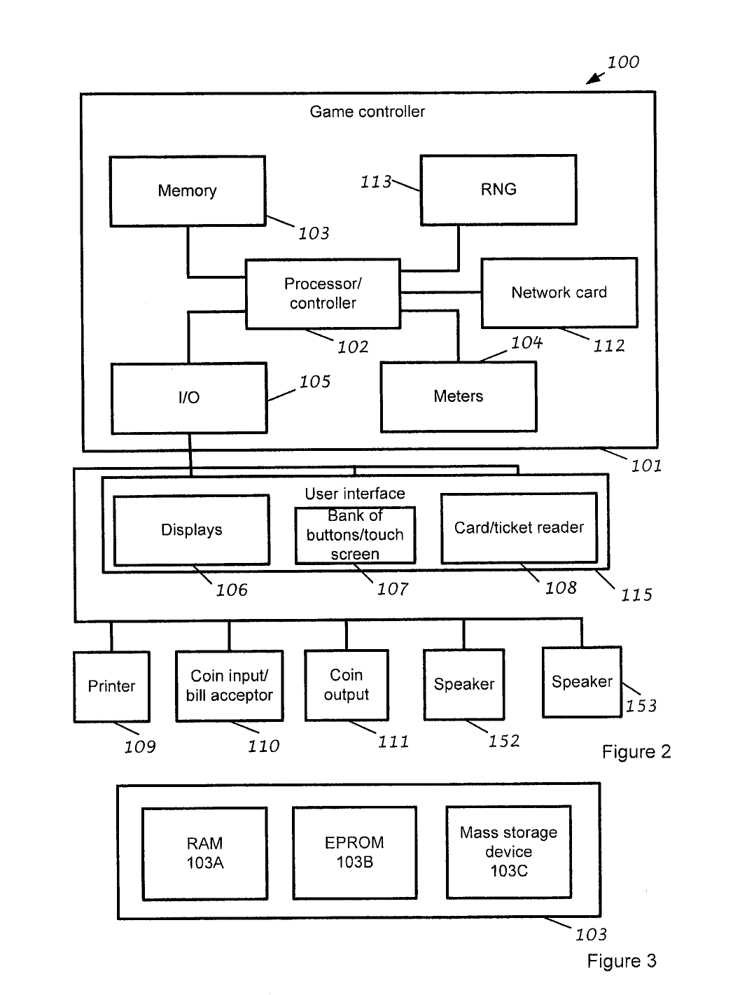

FIG. 2 shows a block diagram of a gaming machine, generally referenced by arrow 100, suitable for implementing certain embodiments of the present invention. The gaming machine 100 may include the gaming console 114 shown in FIG. 1 and accordingly like reference numerals have been used to describe like components in FIGS. 1 and 2.

The gaming machine 100 includes a game controller 101, which in the illustrated example includes a computational device 102 that may be a microprocessor, microcontroller, programmable logic device or other suitable device. Instructions and data to control operation of the computational device 102 are stored in a memory 103, which is in data communication with, or forms part of, the computational device 102. Typically, the gaming machine 100 will include both volatile and non-volatile memory and more than one of each type of memory, with such memories being collectively represented by the memory 103. The instructions to cause the game controller 101 to implement the present invention may be stored in the memory 103. The instructions and data may be conveyed to the gaming machine by means of a data signal in a transmission channel. Examples of such transmission channels include network connections, the Internet or an intranet and wireless communication channels.

The game controller 101 may include hardware credit meters 104 for the purposes of regulatory compliance and also include an input/output (I/O) interface 105 for communicating with the peripheral devices of the gaming machine 100. The input/output interface 105 and/or the peripheral devices may be intelligent devices with their own memory for instructions and data.

In the example shown in FIG. 2, the peripheral devices that communicate with the controller are the displays 106, bank of buttons/touch screen 107, the card and/or ticket reader 108, the printer 109, a bill acceptor and/or coin input 110 and a coin output 111. Additional devices may be included as part of the gaming machine 100, or devices omitted as required for the specific implementation.

Speakers 152, 153 also communicate with the game controller 101. The controller includes a stereo driver operable to drive each of the speakers 152, 153 individually. The stereo device driver may be implemented as integrated circuitry with firmware in the game controller 101. Alternatively, the stereo driver may be implemented as software code running, for example on the computational device 102. In other arrangements the driver is a multi-channel driver that enables more than two channels to be output to a plurality of speakers that communicate with the game controller 101.

The bank of buttons 107A and/or touch screen 107B together with one or both of the displays 106 may provide a user interface 115 through which the gaming machine 100 and player communicate. If a card/ticket reader 108 is provided, this may also form part of the user interface 115.

In addition, the gaming machine 100 may include a communications interface, for example a network card 112. The network card 112, may for example, send status information, accounting information or other information to a central controller, server or database and receive data or commands from a the central controller, server or database. The network card 112 may also enable communication with a central player account, allowing cashless gaming. One or more of the peripheral devices, for example the card/ticket reader 108 may be able to communicate directly with the network card 112. The network card 112 and the I/O interface 105 may be suitably implemented as a single-machine communications interface.

The game controller 101 may also include a random number generator 113, which generates a series of random numbers that determine the outcome of a series of random game events played as part of a game on the gaming machine 100.

The game controller 101 may have distributed hardware and software components that communicate with each other directly or through a network or other communication channel. In particular, the game controller 101 may be located in part or in its entirety remote from the user interface 115. Also, the computational device 102 may comprise a plurality of devices, which may be local or remote from each other.

Instructions and data for controlling the operation of the user interface 115 may be conveyed to the user interface 115 by means of a data signal in a transmission channel. The user interface 115 may be a computational device, for example a personal computer, used by a person to play a game provided from a remote game controller 101.

FIG. 3 shows an exemplary block diagram of the main components of the memory 103. The RAM 103A typically temporarily holds instructions and data related to the execution of game programs and communication functions performed by the computational controller 102. The EPROM 103B may be a boot ROM device and/or may contain system and game-related code. The mass storage device 103C may be used to store game programs, the integrity of which may be verified and/or authenticated by the computational controller 102 using protected code from the EPROM 103B or elsewhere.

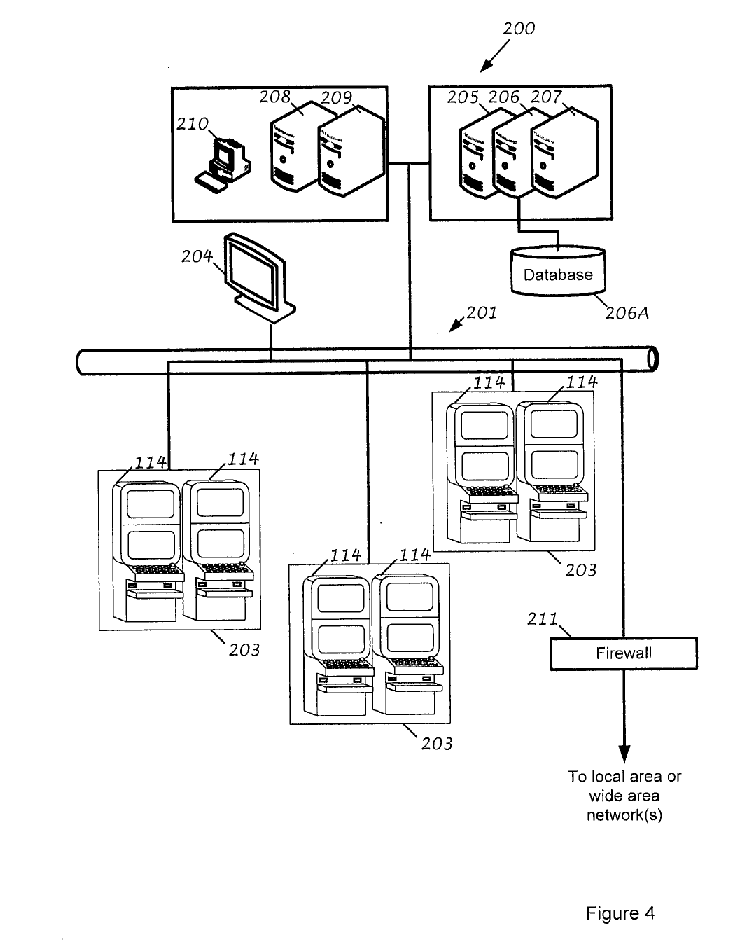

FIG. 4 shows a gaming system 200 in the form of a network of devices. The gaming system 200 includes a network infrastructure 201, which for example may be an Ethernet network. Alternatively, a wireless network and/or direct communication channels, or a different type of network may be used to link the gaming machines to a server, each other and/or other devices. Gaming consoles 114, shown arranged in three banks 203 of two gaming consoles 114 in FIG. 4, are connected to the network infrastructure 201. The gaming consoles 114 may form part or all of a gaming machine 100. Single gaming consoles 114 and banks 203 containing three or more gaming devices 114 may also be connected to the network infrastructure 201, which may also include hubs, routers, bridges to other networks and other devices (not shown).

One or more displays 204 may also be connected to the network 201. The displays 204 may, for example, be associated with a bank 203 of gaming consoles 114. The displays 204 may be used to display representations associated with game play on the gaming devices 202, and/or used to display other representations, for example promotional or informational material.

Servers may also be connected to the network 201. For example, a game server 205 may generate game outcomes for games played on one or more of the gaming consoles 114, a database management server 206 may manage the storage of game programs and associated data in a database 206A so that they are available for downloading to, or access by, game controllers 101, and a jackpot server 207 may control one or more jackpots for the gaming system 200.

Further servers may be provided to assist in the administration of the gaming system 200, including for example a gaming floor management server 208, and a licensing server 209 to monitor the use of licenses to particular games. An administrator terminal 210 is provided to allow an administrator to manage the network 201 and the devices connected to the network. The gaming floor management server 208 may act as a player tracking server.

The gaming system 200 may communicate with other gaming systems, other local networks, for example a corporate network and/or a wide area network such as the Internet through a firewall 211.

Providing Stereo Sound Effects for a Game

In the method described below, the stereo driver of the game controller 101 plays gaming sounds over left speaker 152 and right speaker 153 to accompany a sequence of events in a game played on a machine such as gaming machine 100. The relative volume in the speakers 152 and 153 varies to match the location of the displayed gaming events.

The described example uses spinning reel games. Similar techniques may also be used to provide sound effects in other games played on gaming machine 100 such as card games, ball games, dice games and pick and match games. This list is not exhaustive. The described methods may be used if the game uses a series of gaming events displayed at a sequence of different locations on the displays 106.

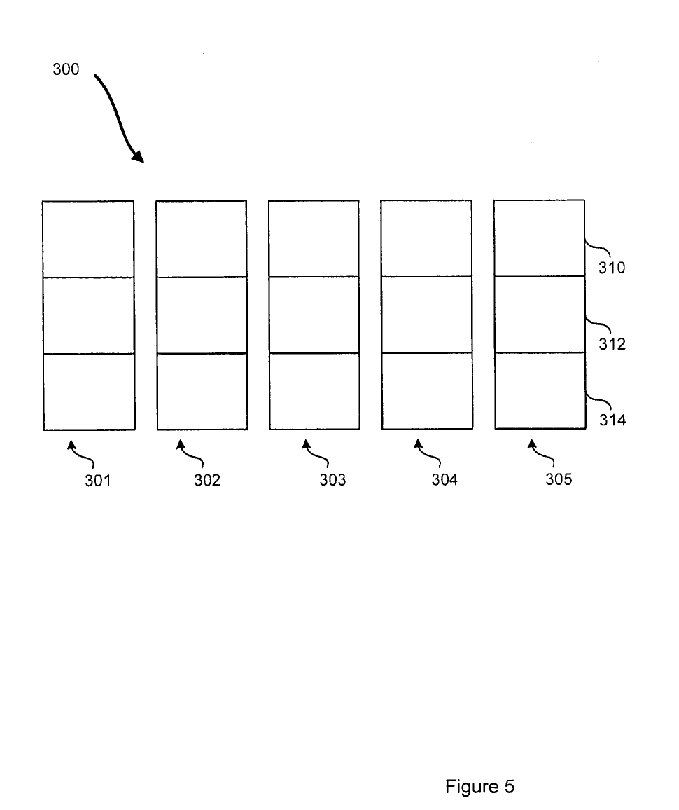

FIG. 5 shows a schematic view 300 of a spinning reel game that may be displayed on display 106A. In one arrangement five reels 301, 302, 303, 304, 305 are displayed. Each of the reels has a series of symbols, of which three are visible in the displayed view 300 at any time. For example, when reel 305 is stopped, symbols are visible in each of cells 310, 312, 314. Originally, gaming machines used physical reels with symbols mounted on the reels. Now, typically, electronic displays such as display 106A use computer graphics to simulate the spinning of physical reels.

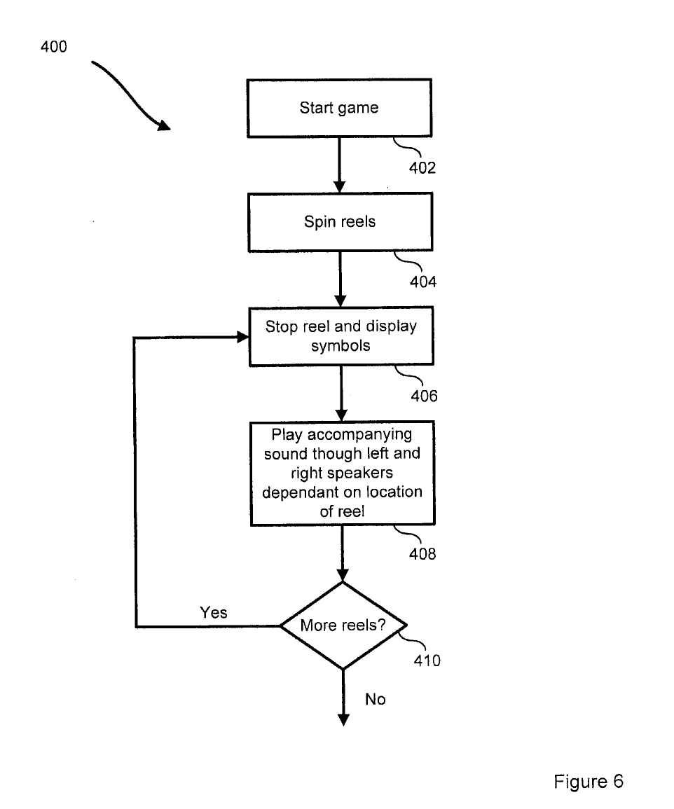

FIG. 6 shows a flow diagram of a method 400 for providing sound effects for a spinning reel game played on gaming console 114. It will be appreciated that the process may also be implemented on other gaming systems. The method 400 is typically controlled by software running on computational device 102 to control the operation of gaming machine 100.

The method 400 commences in step 402, in which the spinning reel game is started. Typically, the game controller 101 monitors the bill acceptor and/or coin input 110 and/or information received by the card/ticket reader 108 or network card 112 for a deposit of credit and in response causes the hardware meters 104 to increment according to the denomination of the game. The game controller 101 then monitors the user interface 107 for the input of a wager. If there are sufficient credits in the meters 104 to support the wager, the game controller 101 commences game play.

In step 404 the reels 301-305 are set spinning. Then, in steps 406-410, the reels are stopped in turn to display 3 symbols each. The outcome of the wagering game depends on the specific combinations of symbols that are revealed when the reels have stopped.

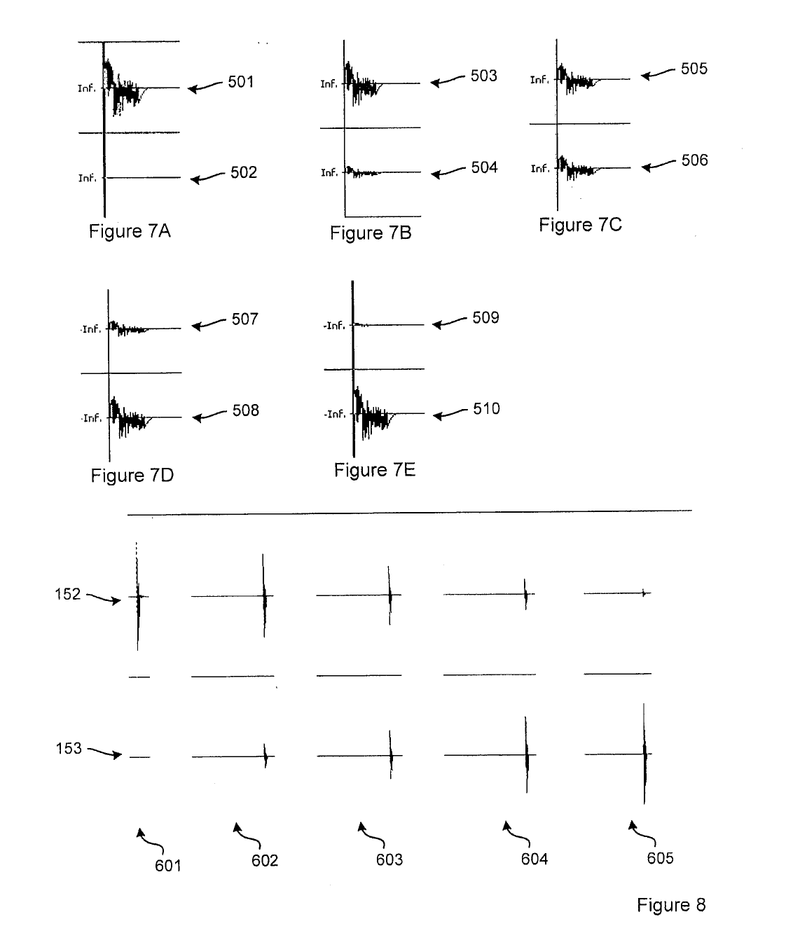

Traditionally, the reels 301-305 stop spinning in turn from left to right. Thus, in the first operation of step 406 the left-hand reel 301 stops spinning to display 3 symbols. The game has a sound that is used to accompany a reel stopping. In step 408 the accompanying sound is retrieved and is played through left speaker 152 and right speaker 153. The relative volume of the gaming sound played through the left and right speakers depends on the location of the reel that has stopped. In the case of reel 301 the sound is played predominantly or entirely through the left speaker 152. This is illustrated in FIG. 7A, which shows 2 sound outputs 501 and 502. In FIG. 7, the x-axis is time and the y-axis is representative of the volume of sound. Output 501 is played through the left speaker 152 and output 502 is played through the right speaker. It may be seen that little or no sound issues from the right speaker 153. Accordingly, a player at the gaming machine 100 will see the left hand reel 301 stopping and hear an accompanying gaming sound through the left speaker 152.

Steps 406 and 408 are coordinated by the controlling software such that the visually displayed event and the accompanying sound are temporally associated. A player may thus expect to hear the accompanying sound if the spinning reel is stopped. The exact time relationship between the displayed event and the sound may be specified by a designer of the game. For example, the sound may immediately precede the event, coincide with the event, follow soon after the event or continue for a time span that encompasses the display of the event.

The stereo pair 501, 502 may be retrieved from data storage, for example memory 103. Since the location of reel 301 in view 300 is known in advance, the relative strength of the respective outputs 501, 502 may be determined in advance and stored in sound files for use in association with reel 301. In alternative arrangements, the relative strength of the right and left outputs may be determined dynamically as a function of the location of a gaming event on the display 106A.

In step 410 the controlling software checks whether there are more reels to stop. As there are, control flow returns to step 406, in which reel 302 stops to reveal 3 symbols. In step 408 a sound is played through speakers 152, 153 to accompany the stopping of reel 302. The sound output is illustrated in FIG. 7B. Sound output 503 issues from left speaker 152 and output 504 is played through right speaker 153. The relative volumes of outputs 503, 504 favour the left speaker 152.

The process then loops back to step 406 in which the next reel 303 is stopped to display 3 symbols. In step 408 an accompanying sound is played, as illustrated in FIG. 7C. Sound output 505 is played through the left speaker 152 and sound output 503 is played through the right speaker 153. Reel 303 is located in the centre of the display 300. Ideally, the sound for reel 303 is heard equally from the left speaker 152 and the right speaker 153, as seen in FIG. 7C.

Process flow then returns to step 406 in which the next reel 304 stops. In step 408 an accompanying sound is played as illustrated in FIG. 7D. In this case, the output 508 played through right speaker 153 is relatively louder than the output 507 played through the left speaker 152.

Process flow then returns to step 406, in which the final reel 305 is stopped. In step 408 the accompanying sound is played as shown in FIG. 7E. Output 510 is played through right speaker 153 and predominates over the relatively quiet sound 509 that is played through the left speaker 152.

Step 410 then checks whether there are any more reels. As there are not, process flow continues to the remaining steps of the game. These further steps are not shown in FIG. 6, but typically relate to determining whether the displayed symbols on the stopped reels entitle the player to a prize or bonus feature.

FIG. 8 provides an overview of the sound outputs of speakers 152, 153 as each of the reels 301-305 stops in sequence. The output sounds are shown on a consistent scale and illustrate how the output of the left speaker 152 progressively diminishes and the output of the right speaker progressively increases as the corresponding reel stops on display 300. The stereo pairs 601, 602, 603, 604, 605 may be designed in advance and stored in data storage such as memory 103. The appropriate stereo pair 601-605 may be retrieved from data storage to accompany a gaming event such as a reel 301-305 stopping. Alternatively, a gaming sound may be retrieved from data storage and be played over speakers 152, 153 with the relative strength of the output signal in each channel being dynamically determined as a function of the location of a gaming event on the display 106A.

It will be appreciated that other sequences of events may be used. For example, the reels may stop in turn from right to left or in a different order.

The method 400 may be adapted for other games. For example, a series of packs of cards may be shown on display 106A, the packs ranging in location from the left hand side of the screen to the right hand side of the screen. A card may be revealed sequentially from each of the packs and a sound may be played through speakers 152, 153 to accompany the revealing of the card. As before, the relative dominance of speakers 152, 153 may be varied in accordance with the location of the event on display 106A.

As described above, the sounds 501-510 accompany the stopping of reels 301-305 respectively. The actual timing of the gaming sound relative to the visual display of the corresponding gaming event may be determined by the game designer. Thus, for example, the accompanying sound may be played to coincide with or follow immediately after the stopping of the reel 301-305. Alternatively, the accompanying sound may be played while the reel slows down and stops.

In the spinning reel game described above, each gaming event occurs at a corresponding location. In other games, the gaming event may involve motion between the left and right sides of the display 106A. For example, a graphic representation of a ball may move across display 106A. The moving ball may be accompanied by a stereo sound played through speakers 152, 153. The relative volume of the gaming sound played through each speaker 152, 153 may vary corresponding to the movement of the ball. For example, if the ball moves from left to right, the sound may be initially louder in the left channel and then progressively become relatively louder in the right channel.

While the foregoing description has been provided by way of example of certain embodiments of the present invention as presently contemplated, which utilize gaming machines of the type found in casinos, those skilled in the relevant arts will appreciate that certain embodiments of the present invention also may have application to internet gaming and/or have application to gaming over a telecommunications network, where handsets are used to display game outcomes and receive player inputs. For the described stereo features to have effect, the device on which the game is played is provided with at least two separately drivable speakers.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A gaming machine comprising:
a display operable to display a sequence of gaming events in a wagering game, each gaming event in the sequence being displayed at a respective location on the display; and
a plurality of speakers operable to play gaming sounds to accompany the sequence of gaming events, wherein a relative volume of each gaming sound in each speaker depends on the location of the corresponding displayed gaming event.

2. A gaming machine according to claim 1, wherein the display is operable to display a plurality of spinning reels in the wagering game and the sequence of gaming events comprises the spinning reels stopping in turn to show at least one symbol.

3. A gaming machine according to claim 1, wherein the plurality of speakers play a gaming sound to accompany a corresponding spinning reel stopping on the display.

4. A gaming machine according to claim 1, wherein the plurality of speakers comprises a left speaker and a right speaker and the display has a left side and a right side wherein, in the wagering game, the plurality of reels is distributed between the left side and the right side and the relative volume of the gaming sound on the left speaker and the right speaker depends on the relative location of the corresponding reel between the left side and the right side.

5. A gaming machine according to claim 1, the gaming machine further comprising data storage to store at least one gaming sound.

6. A gaming machine according to claim 5, wherein the data storage stores the or each gaming sound as a stereo pair.

7. A gaming machine according to claim 5, the gaming machine further comprising means to retrieve at least one gaming sound from the data storage and a driver to play the retrieved sound over the plurality of speakers.

8. A gaming machine according to claim 1, wherein the location of the gaming event moves during display of the gaming event and the relative volume of accompanying gaming sound played through the speakers varies corresponding to the movement of the location of the displayed gaming event.

9. A method of providing sound effects for a wagering game played on a gaming machine having a display and a plurality of speakers, the method comprising:
displaying a sequence of gaming events in the wagering game, each gaming event being displayed at a respective location on the display; and, for each displayed gaming event
playing a gaming sound through the plurality of speakers to accompany the displayed gaming event, wherein a relative volume of the gaming sound in each speaker depends on the location of the displayed gaming event.

10. A method according to claim 9, the method further including operating the display to display a plurality of spinning reels in the wagering game, and the sequence of gaming events comprises the spinning reels stopping in turn to show at least one symbol.

11. A method according to claim 9, the method further including playing a gaming sound on the plurality of speakers to accompany a corresponding spinning reel stopping on the display.

12. A method according to claim 9, wherein the plurality of speakers comprises a left speaker and a right speaker and the display has a left side and a right side wherein, in the wagering game, the plurality of reels is distributed between the left side and the right side, and wherein the method further includes varying the relative volume of the gaming sound on the left speaker and the right speaker depending on the relative location of the corresponding reel between the left side and the right side.

13. A method according to claim 9, wherein at least one gaming sound is stored on a data storage.

14. A method according to claim 13, wherein the or each gaming sound is stored on the data storage as a stereo pair.

15. A method according to claim 13, the method further comprising retrieving at least one gaming sound from the data storage and playing the retrieved sound over the plurality of speakers.

16. A method according to claim 9, wherein the location of the gaming event moves during display of the gaming event, the method further including varying the relative volume of accompanying gaming sound played through the speakers according to the movement of the location of the displayed gaming event.

17. Instructions executable by a game controller to implement the method as defined in claim 9.

18. A data signal carrying instructions according to claim 17.

19. A storage medium readable by a game controller, the storage medium storing instructions executable by a game controller to implement the method as defined in claim 9.
